(19) United States
(12) Patent Application Publication
(10) Pub. No.: US 2004/0181555 A1
(43) Pub. Date: Sep. 16, 2004

(54) System and method of delivering information targeted to a user

(75) Inventors: Edward R. Ratner, Golden Valley, MN (US); Branko Strok, Minneapolis, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Infingo, LLC

(21) Appl. No.: 10/386,228

(22) Filed: Mar. 11, 2003

(51) Int. Cl. G06F 7/00

(52) U.S. Cl. 707/200

(57) ABSTRACT

A system and method for delivering user targeted information from a web server to a personal digital assistant (PDA). A personal profile associated with a user is entered, wherein the personal profile includes demographic information associated with the user. Synchronization is initiated, wherein initiating synchronization includes generating a query as a function of the user's demographic information and transmitting the query to a web server. One or more Uniform Resource Locators (URLs) is selected as a function of the query. The computer receives the selected Uniform Resource Locators (URL) and opens web pages corresponding to the received URLs. The computer receives HTML code corresponding to the web pages, parses the received HTML code and converts the parsed HTML code into a format appropriate for the PDA.

### FIELD OF THE INVENTION

The present invention is related to content delivery, and more particularly to a system and method for tuning delivery of information to particular users of that information.

### BACKGROUND INFORMATION

Personal digital assistants have become increasingly common tools for students and professionals. Historically, their use has been to store and organize information entered by the user. Recently, hardware and software has made it possible to use PDA's as a tool to access information from the Internet. Any Web site can be downloaded to a PDA, through a desktop computer, at the time of synchronization of the PDA to the desktop. This is usually accomplished at the push of a button on a hard-wired cradle connected to the desktop.

Currently, there are three methods for updating Web content on a PDA. The first requires users to download files from a web site to their desktop computer and then transfer the files to their PDA during synchronization. The content is only updated when the user remembers to check the web site for updates and downloads the updated file for transfer at the next PDA synchronization.

The second method (used by content distributors like AvantGo and Mazingo) requires that a content provider or intermediary set up a web site and display at that web site a list of content providers that are seeking to disseminate information. PDA users must go to the web site and select the content to be downloaded to their PDAs. Content stored at the web site is compared to previously downloaded content. New or updated content is downloaded automatically through the desktop computer to the PDA.

A third method (used by software programs such as Plucker and Handstory and by PDA users who have wireless access to the Internet and Web browsers on their PDAs) takes a URL entered by the user, retrieves content from that URL and converts the content into a format which can be displayed by the PDA.

To date, content providers have had difficulty publishing their content to users of personal digital assistants (PDAs). Organizations and individuals that want to disseminate information from the World Wide Web to PDAs currently cannot “push” and regularly update information to targeted groups of PDA users.

Avant-Go and Plucker allow the synchronization of Web sites to the PDA through this process. Web sites must be chosen using desktop software for both Avant-Go and Plucker. Avant-Go maintains the database of user chosen Web sites on its server. Plucker maintains the database on the desktop. Avant-Go has synchronization as a one step process. Plucker currently requires a two-step process—the user first enters the Uniform Resource Locator (URL) (and any other options desired) into the Plucker user interface; the Plucker parser creates a file for the Web page data on the desktop. The user must then synchronize the PDA to the desktop to download the data associated with the URL.

Both of these methods require an active (and often multi-step) role by the PDA user to either initially obtain the information, or to update the information. The content provider must regularly advertise their content to the PDA users to entice them to engage with its site. In addition, when content is not aimed specifically at a PDA, the PDA user must take the time to seek out relevant web sites or pages, download the content and keep it updated.

What is needed is a system and method for delivering information to particular users of that information that addresses the issues raised above and other issues that will become apparent in reading the following description of the present invention.

### SUMMARY OF THE INVENTION

The present invention is a system and method for delivering user targeted information from a web server to a personal digital assistant (PDA). A personal profile associated with a user is entered, wherein the personal profile includes demographic information associated with the user. Synchronization is initiated, wherein initiating synchronization includes generating a query as a function of the user's demographic information and transmitting the query to a web server. One or more Uniform Resource Locators (URLs) are selected as a function of the query. The computer receives the selected Uniform Resource Locators (URL) and opens web pages corresponding to the received URLs. The computer receives HTML code corresponding to the web pages, parses the received HTML code and converts the parsed HTML code into a format appropriate for the PDA.

According to another aspect of the present invention, a personal profile associated with a user is entered, wherein the personal profile includes demographic information associated with the user. In addition, search parameters are entered. Synchronization is initiated, wherein initiating synchronization includes generating a first query as a function of the user's demographic information and a second query as a function of the search parameters. The queries are then transmitted to a web server. One or more Uniform Resource Locators (URLs) are selected as a function of the queries. The computer receives the selected Uniform Resource Locators (URL) and opens web pages corresponding to the received URLs. The computer receives HTML code corresponding to the web pages, parses the received HTML code and converts the parsed HTML code into a format appropriate for the PDA.

According to another aspect of the present invention, a personal profile associated with a user is entered, wherein the personal profile includes demographic information associated with the user. The user enters a URL and initiates synchronization, wherein initiating synchronization includes generating a query as a function of the user's demographic information and transmitting the query to a web server. One or more Uniform Resource Locators (URLs) are selected as a function of the query. The computer receives the selected Uniform Resource Locators (URL) and opens web pages corresponding to the user-defined URL and to the received URLs. The computer receives HTML code corresponding to the web pages, parses the received HTML code and converts the parsed HTML code into a format appropriate for the PDA.

According to another aspect of the present invention, a web server is defined for delivering information targeted to a user. The web server includes means for transmitting data over a network; means for receiving a query generated from a personal profile associated with the user, wherein the personal profile includes demographic information associated with the user; means for selecting one or more Uniform Resource Locators (URLs) as a function of the query; and means for returning the selected URLs to the user over the network.

According to another aspect of the present invention, a computer is defined requesting, from a web server, information targeted to a user. The computer includes a processor and a user interface, wherein the user interface includes means for entering a personal profile associated with a user, wherein the means for entering a personal profile includes means for selecting from pre-defined categories associated with an affinity group and means for entering geographic location information associated with the user. The computer further includes means, connected to the processor and the user interface, for generating a query as a function of the personal profile and means for transmitting the query across a network to a web server.

### BRIEF DESCRIPTION OF THE DRAWINGS

In the drawings, like numerals describe substantially similar components throughout the several views. Like numerals having different letter suffixes or primed (X′) represent different occurrences of substantially similar components.

FIG. 1 is a schematic diagram of a information delivery system in accordance with the present invention;

FIGS. 2-4 are methods of delivering information in accordance with the present invention;

FIGS. 5-8 show an embodiment of a user interface according to the present invention; and

FIG. 9 illustrates a method of delivering information in accordance with the present invention.

### DESCRIPTION OF THE PREFERRED EMBODIMENTS

In the following detailed description of the preferred embodiments, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

In the following description and claims, the terms “coupled” and connected,” along with their derivatives, may be used. It should be understood that these terms are not intended as synonyms for each other. Rather, in particular embodiments, “connected” may be used to indicate that two or more elements are in direct physical or electrical contact with each other. However, “coupled” may also mean that two or more elements are not in direct contact with each other, but yet still co-operate or interact with each other.

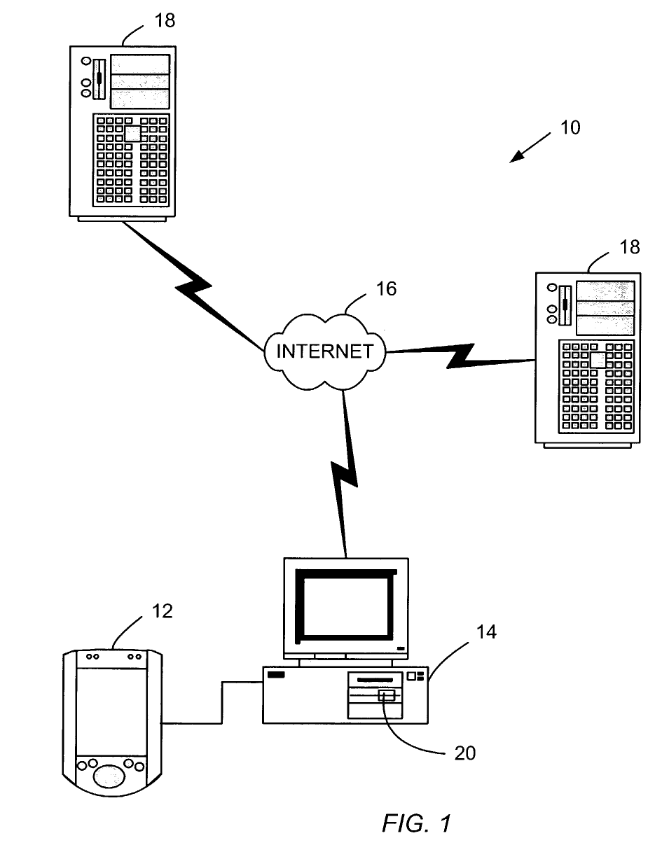

One embodiment of an information delivery system 10 is shown in FIG. 1. In the embodiment shown in FIG. 1, a personal digital assistant 12 connects through a computer 14 to the Internet 16, and through the Internet 16 to one or more web servers 18. Web servers 18 provide web pages for download to PDA 12. In one embodiment, computer 14 includes a computer readable medium reader 20 capable of accessing data on computer readable media. Examples of such readers 20 include read-write and read-only memory devices. Floppy disks, hard drives, CD-ROM drives and DVD drives are all examples of computer readable medium readers 20.

A user enters personal data into computer 14 or PDA 12 and it is stored as a personal profile. In one embodiment, the profile is stored on a hard drive within computer 14. The profile could, however, be stored in any form of volatile or nonvolatile memory within either or within both computer 14 and PDA 12.

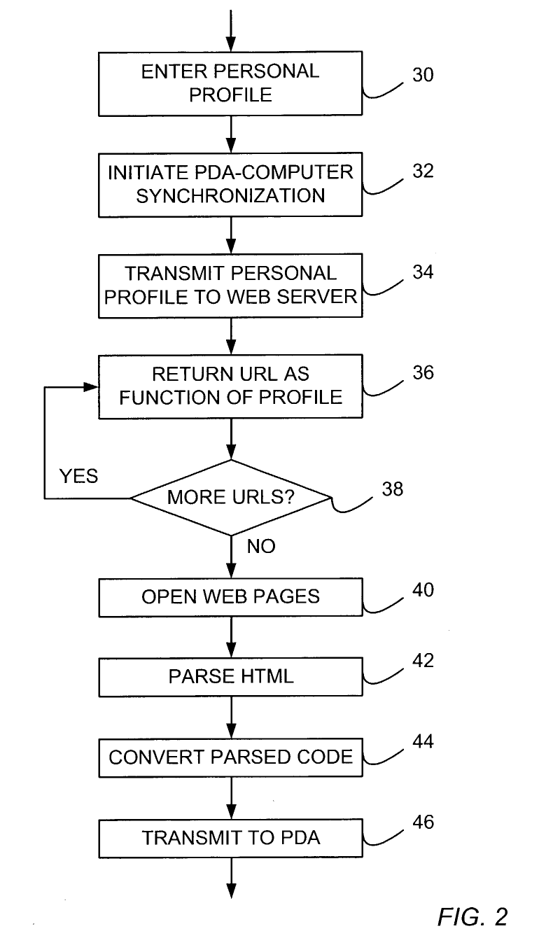

A method for tuning delivery of information from a Web site to particular PDA users within system 10 will be discussed next. As is shown in FIG. 2, at 30 a PDA user enters personal profile information into PDA 12 or computer 14. The PDA user then initiates PDA-to-computer synchronization at 32. At 34, computer 14 accesses a web site server 18 over Internet 16 and transmits the personal profile information to web server 18. At 36, web server 18 executes a query based on the personal profile information and obtains a Uniform Resource Locator (URL) as a function of the information in the personal profile. A check is made at 38 to see if all URLs have been retrieved. If not, control moves to 36 and an additional URL is obtained.

If, at 38, server 18 determines that no other URLs exist, control moves to 40 and web pages corresponding to the URLs obtained are opened and their contents delivered as HTML source code to computer 14. In one embodiment, the content is stored in a cache within computer 14. Control then moves to 42, where the HTML is parsed. At 44, the parsed HTML source code is converted into a PDA-friendly format. At 46, computer 14 transmits the converted HTML source code to PDA 12.

In one embodiment, no formal programmatic checks are done after each URL is sent back to the client. Instead, all URLs are sent embedded in a single HTML document. The tag at the end of that document (“</html>”) signals to computer 14 that all URLs to be parsed have been received. Control then moves to 40 and web pages corresponding to the URLs obtained are opened and their contents delivered as HTML source code to computer 14.

In one embodiment, some of the functionality shown in FIG. 2 can be obtained using a software package called Plucker. (Plucker is an offline web and eBook viewer for Palm OS® based handheld devices available from http://www.plkr.org/index.plkr.) Plucker can be used to, for instance, download data from each web site to PDA 12. The converted HTML source code file is then read using a browser on PDA 12.

In one embodiment, computer 14 includes a user interface program used to simplify entry of personal information into a PDA user's personal profile. In one embodiment, the user interface program saves the profile onto a hard disk within computer 14.

In one embodiment, PDA 12 includes a user interface program used to simplify entry of personal information into a PDA user's personal profile. In one embodiment, the user interface program saves the profile in nonvolatile memory within PDA 12.

In one embodiment, PDA 12 is nonvolatile memory such as a smart card which is operated simply by plugging the card into a user interface.

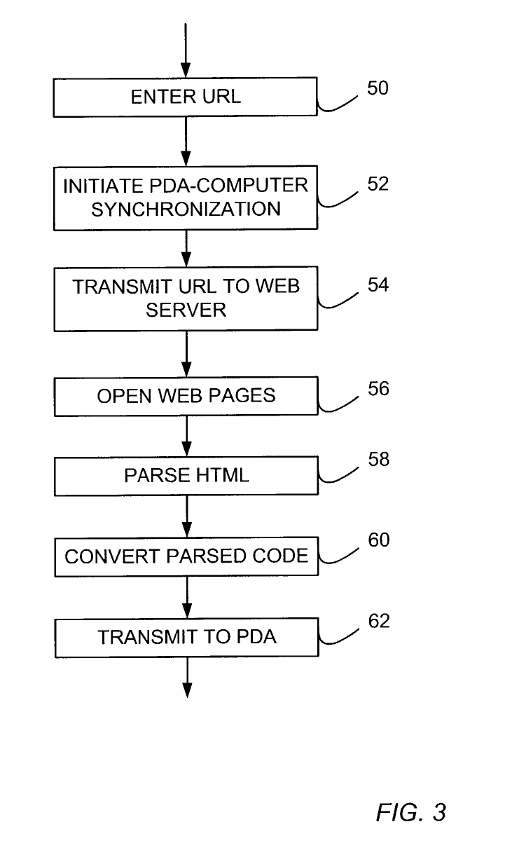

In one embodiment, the user interface program includes a method of entering a URL associated with a desired web page. As is shown in FIG. 3, at 50 a PDA user enters a URL into PDA 12 or into computer 14. The PDA user then initiates PDA-to-computer synchronization at 52. At 54, computer 14 accesses a web site server 18 over Internet 16 and transmits the URL to web server 18. At 56, web server 18 opens a page or pages corresponding to the URL and transmits their contents as HTML source code to computer 14. In one embodiment, the content is stored in a cache within computer 14. Control then moves to 58, where the HTML code is parsed. At 60, the parsed HTML source code is converted into a PDA-friendly format. At 62, computer 14 transmits the converted HTML source code to PDA 12.

The converted HTML source code file is then read using a browser on PDA 12.

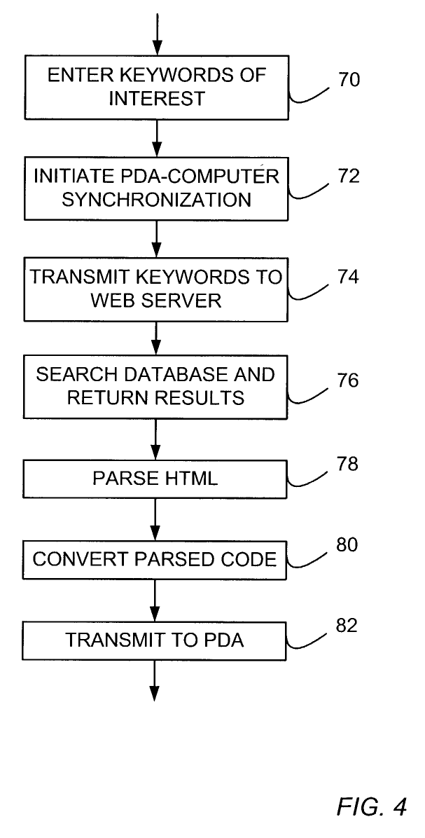

In one embodiment, the user interface program includes a method of entering search parameters. As is shown in FIG. 4, at 70 a PDA user enters the search parameters into PDA 12 or into computer 14. The PDA user then initiates PDA-to-computer synchronization at 72. At 74, computer 14 accesses a web site server 18 over Internet 16 and transmits the search parameters to web server 18. At 76, web server 18 generates a list of web sites corresponding to the search parameters and transmits the list as HTML source code to computer 14. In one embodiment, the list is a list of URLs; the list is stored in a cache within computer 14. Control then moves to 78, where the HTML code is parsed. At 80, the parsed HTML source code is converted into a PDA-friendly format. At 82, computer 14 transmits the converted HTML source code to PDA 12.

The converted HTML source code file is then read using a browser on PDA 12.

In one embodiment, both the list of URLs and their corresponding web pages are downloaded at 76.

In one embodiment, the user interface program is stored on a computer-readable medium and is accessed using computer readable medium reader 20.

In one embodiment, the user interface program generates a query based on the personal profile entered by the user. That query is transmitted to web server 18 and causes web server 18 to transmit to computer 14 either web pages or the URLs of web pages that are relevant to somebody with the characteristics in the profile. In one such embodiment, computer 14 resends the query at a predefined update interval (set by the user or by the service provider) in order to update the data stored on computer 14. For instance, a service provider may update the data each time the PDA is synchronized in order to ensure that the user has the most recent web page associated with each URL. Or, a service provider may have computer 14 query web server 18 in the background at some predefined interval (e.g., daily or weekly). Either way, the result is a targeted push of data relevant to the user.

In another such embodiment, web server 18 stores the query and reviews it at a predefined update interval (set by the user or by the service provider) in order to update the data stored on computer 14.

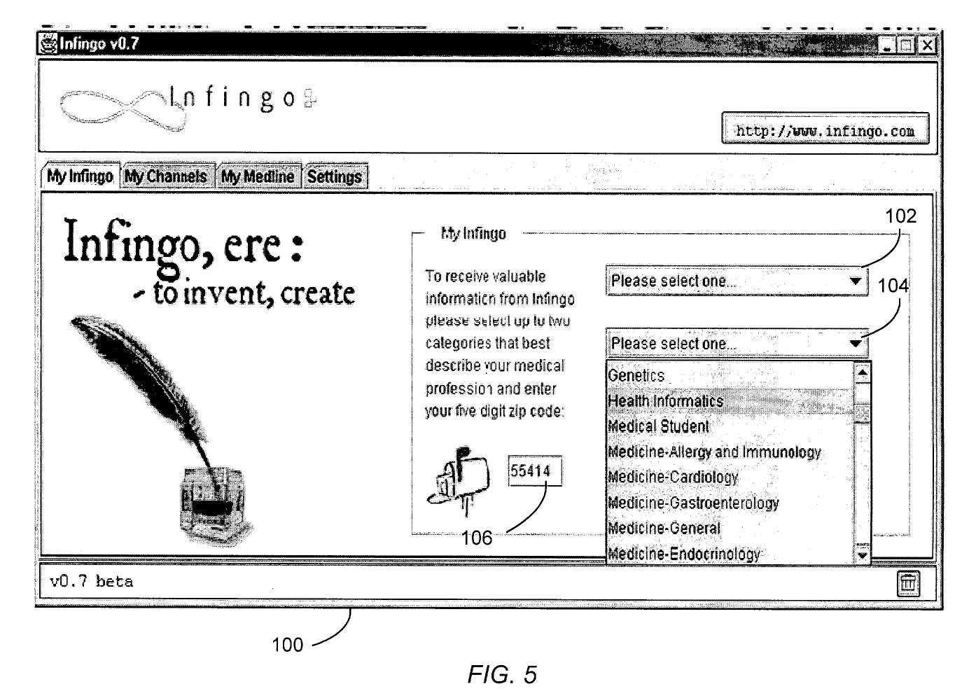

As noted above, in one embodiment, computer 14 includes a user interface program used to simplify entry of personal information into a PDA user's personal profile. One such user interface is shown in FIG. 5. In the user interface 100 shown in FIG. 5, a user sets up his profile by clicking on the “My Infingo” tab. In the example shown, the web site is geared to users of PDAs in the medical profession. Similar web sites could be set up for other professions, for hobbyists, or for other affinity groups.

In the user interface shown in FIG. 5, a user selects up to two categories at 102 and 104 that best describes their profession. The user also enters geographic location information (such as zip code and/or country of residence) at 106. Computer 14 then generates a query based on the two categories selected and the geographic location information to return data relevant to a PDA user matching that profile.

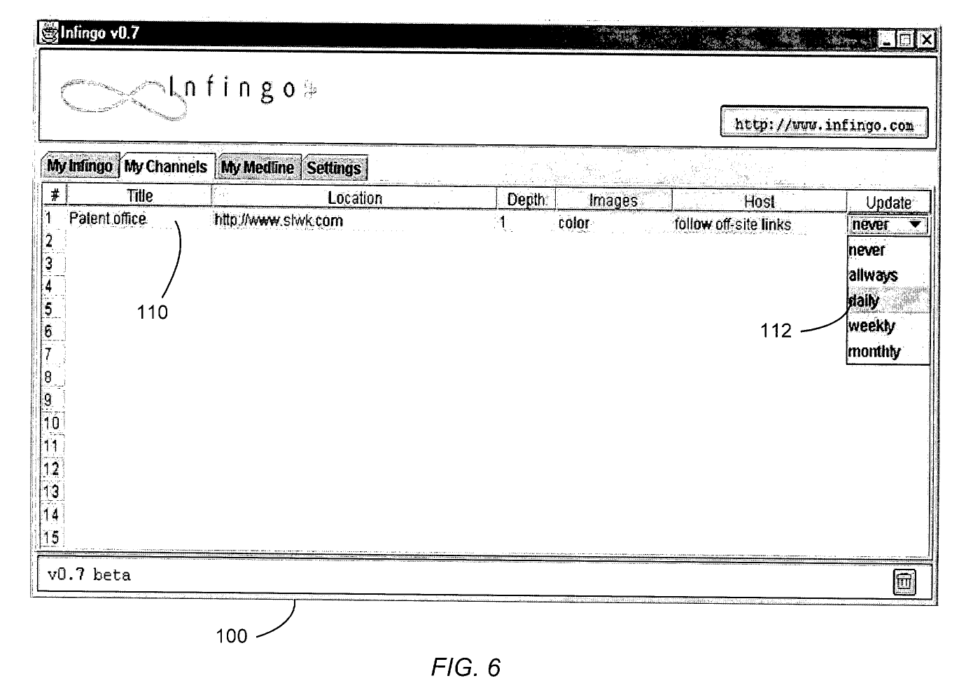

In one embodiment, the user can also enter a URL to monitor pre-selected web sites. One such user interface is shown in FIG. 6. In the user interface 100 shown in FIG. 6, a user enters one or more URLs at 110 and selects an update frequency at 112. Computer 14 then generates a query based on the URLs in the list at the frequency selected for each URL. For instance, a first URL may be updated weekly and a second URL may be updated daily. When the PDA owner synchronizes, computer 14 determines if the first URL has been updated in the last week. If so, it is not added to the query. Computer 14 also determines if the second URL has been updated in the last day. If so, it is not added to the query. The query with the URLs to be updated is then sent to the relevant web server or servers 18.

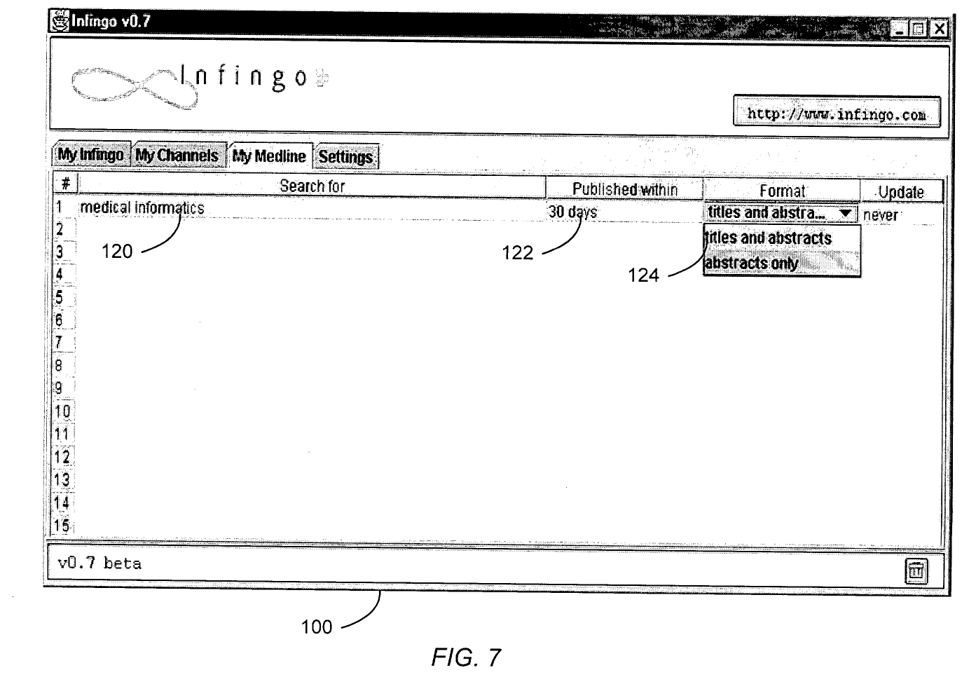

In one embodiment, users enter one or more search parameters (e.g., key words for a key word search) for a search of documents relevant to their user profile. One such user interface is shown in FIG. 7. In the user interface 100 shown in FIG. 7, a user enters search parameters including one or more key words at 120, selects a time period of interest at 122 and selects an update interval at 124. Computer 14 then generates a separate search for each search parameter and submits it to one or more pre-selected search engines. The results of the search are filtered to remove results that fall outside the selected time period for that particular search. The filtered search results are sent to computer 14 in the method described for FIG. 4 above.

In one embodiment, searches are performed at the update interval shown in 124 in a manner similar to that discussed for FIG. 6 above.

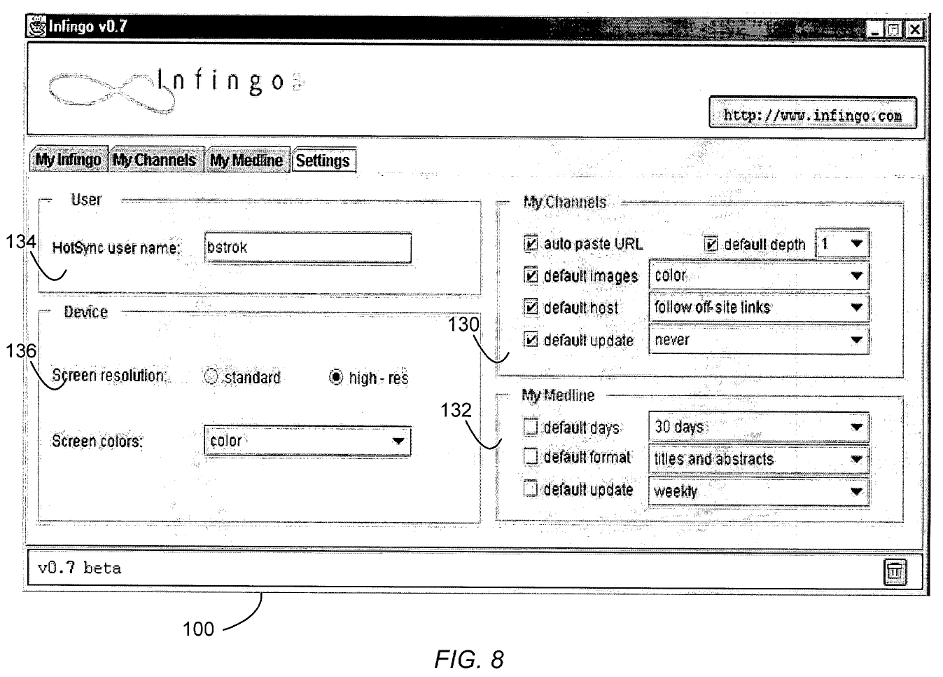

In one embodiment, users enter other parameters relevant to their use of system 10. In one embodiment, as is shown in FIG. 8, default parameters relevant to each of the different searches are entered at 130 and 132. Other parameters can be entered such as are shown in PDA parameters 134 and computer parameters 136.

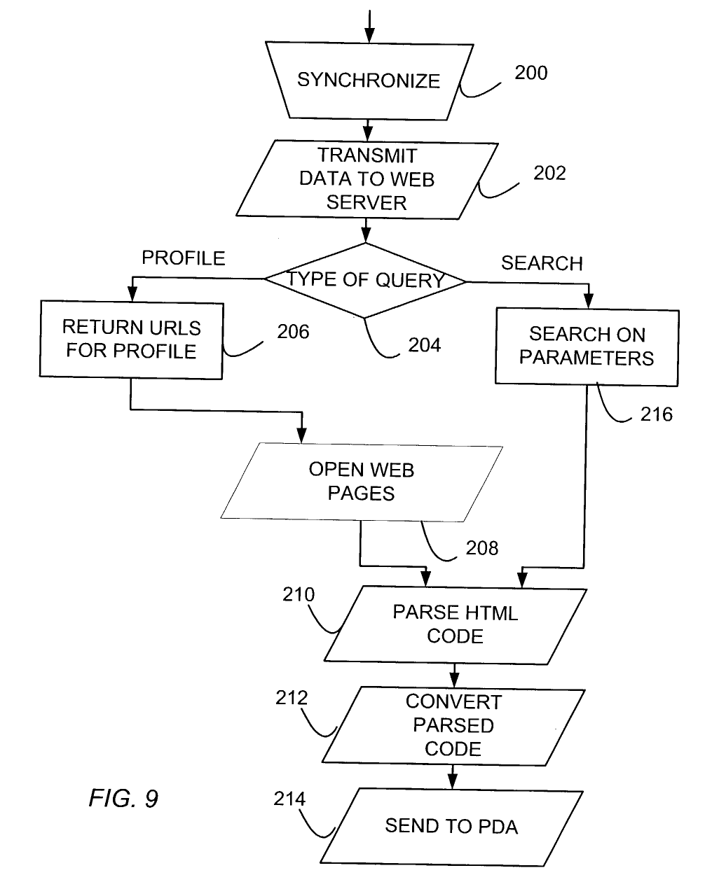

An embodiment of system 10 that operates on personal profiles, user-defined URLS and user-defined search parameters will be described next with reference to FIG. 9. As noted above, the user enters or selects demographic data in the user interface. Demographics data is then used by the user interface program to construct a URL containing CGI name/value pairs parameters related to the options, choices and data entered by the user. In one embodiment, that URL is stored on computer readable media within computer 14 (e.g., in the “INI” file containing settings for the client software operating on computer 14). The user then initiates synchronization for PDA 12 at 200.

On synchronization, client software in computer 14 starts and reads the settings and URL stored by the user interface. Client software on computer 14 then sends, at 202, a HTTP or HTTPS request to web server 18 requesting the web page described in the URL.

Server software operating on web server 18 accepts the connection at 204 and receives the URL containing CGI parameters. The server software notes that the URL is related to demographic data operations and moves to 206 where the CGI parameters containing name/value data pairs related to the user demographic preferences are extracted. Server software then accesses a server database that contains the data that identifies and relates the web pages with particular demographic data and runs a SQL query against the database using data extracted from the CGI parameters. The database query returns data which contains the URL's, depth, graphics and other preferences that identify web pages specifically related to the user's demographics data. This data is returned to computer 14 at 208.

Computer 14 opens the web pages at 208 and receives HTML source code corresponding to the web pages. In one embodiment, Plucker is used to collect the desired web pages.

Computer 14 then parses the HTML code at 210, converts the parsed code to a PDA-compatible format at 212 and transmits the converted web pages to PDA 12 at 214.

In one embodiment, the database query at 206 returns URLs or other data associated with banner advertisements targeted at users meeting the demographics of the user. The banner advertisements are combined with the other content and displayed on the user's PDA 12.

A search for relevant data based on user-defined search parameters will be described next. If, at 202, computer 14 transmits search parameters to web server 18, control moves through 204 to 216, where a search is performed using the user-defined parameters. The results of the search are returned to computer 14 as HTML code at 210. Computer 14 then parses the HTML code at 210, converts the parsed code to a PDA-compatible format at 212 and transmits the converted web pages to PDA 12 at 214.

What has been described is a system and method for downloading targeted user data from a web server to a PDA. This approach provides a targeted push which can be used to deliver more finely tuned content to the user.

In the above discussion and in the attached appendices, the term “computer” is defined to include any digital or analog data processing unit. Examples include any personal computer, workstation, set top box, mainframe, server, supercomputer, laptop or personal digital assistant capable of embodying the inventions described herein.

Portions of the above description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention. Therefore, it is intended that this invention be limited only by the claims and the equivalents thereof.

What is claimed is:

1. A method for delivering user targeted information from a web server to a personal digital assistant (PDA), the method comprising:
entering a personal profile associated with a user, wherein the personal profile includes demographic information associated with the user;
initiating synchronization, wherein initiating synchronization includes generating a query as a function of the user's demographic information and transmitting the query to a web server;
selecting one or more Uniform Resource Locators (URLs) as a function of the query;
receiving the selected Uniform Resource Locators (URL);
opening web pages corresponding to the received URLs;
receiving HTML code corresponding to the web pages;
parsing the received HTML code; and
converting the parsed HTML code into a format appropriate for the PDA.

2. The method according to claim 1, wherein entering a personal profile includes selecting from pre-defined categories associated with an affinity group.

3. The method according to claim 1, wherein entering a personal profile includes entering geographic location information associated with the user.

4. The method according to claim 3, wherein the geographic location information includes a zip code.

5. The method according to claim 3, wherein entering a personal profile further includes selecting from pre-defined categories associated with an affinity group.

6. The method according to claim 1, wherein initiating synchronization further includes connecting the PDA to a computer connected to the Internet.

7. The method according to claim 1, wherein the selected URLs include URLs containing advertising targeted to users matching the demographic information associated with the user.

8. An article comprising a computer readable medium having instructions thereon, wherein the instructions, when executed in a computer, create a system for executing the method of claim 1.

9. A method for delivering user targeted information from a web server to a personal digital assistant (PDA), the method comprising:
entering a personal profile associated with a user, wherein the personal profile includes demographic information associated with the user;
initiating synchronization, wherein initiating synchronization includes connecting the PDA to a computer connected to the Internet, generating a query at the computer as a function of the user's personal profile and transmitting the query to a web server;
selecting one or more Uniform Resource Locators (URLs) as a function of the query;
receiving the selected Uniform Resource Locators (URL);
opening web pages corresponding to the received URLs;
receiving HTML code corresponding to the web pages;
parsing the received HTML code;
converting the parsed HTML code into a format appropriate for the PDA; and
transmitting the formatted HTML code to the PDA.

10. The method according to claim 9, wherein the selected URLs include URLs containing advertising targeted to users matching the demographic information associated with the user.

11. The method according to claim 8, wherein entering a personal profile includes selecting from pre-defined categories associated with an affinity group.

12. The method according to claim 8, wherein entering a personal profile includes entering geographic location information associated with the user.

13. The method according to claim 12, wherein the geographic location information includes a zip code.

14. The method according to claim 12, wherein entering a personal profile further includes selecting from pre-defined categories associated with an affinity group.

15. An article comprising a computer readable medium having instructions thereon, wherein the instructions, when executed in a computer, create a system for executing the method of claim 9.

16. A method for delivering user targeted information from a web server to a personal digital assistant (PDA), the method comprising:
entering a personal profile associated with a user, wherein the personal profile includes demographic information associated with the user;
entering search parameters;
initiating synchronization, wherein initiating synchronization includes:
generating a first query as a function of the user's personal profile;
generating a second query as a function of the search parameters; and
transmitting the first and second queries to a web server;
selecting Uniform Resource Locators (URLs) as a function of the first and second queries;
receiving the selected Uniform Resource Locators (URL);
opening web pages corresponding to the received URLs;
receiving HTML code corresponding to the web pages;
parsing the received HTML code; and
converting the parsed HTML code into a format appropriate for the PDA.

17. The method according to claim 16, wherein entering a personal profile includes selecting from pre-defined categories associate with an affinity group.

18. The method according to claim 16, wherein entering a personal profile includes entering geographic location information associated with the user.

19. The method according to claim 18, wherein the geographic location information includes a zip code.

20. The method according to claim 18, wherein entering a personal profile further includes selecting from pre-defined categories associated with an affinity group.

21. The method according to claim 16, wherein initiating synchronization further includes connecting the PDA to a computer connected to the Internet.

22. The method according to claim 16, wherein the selected URLs include URLs containing advertising targeted to users matching the demographic information associated with the user.

23. An article comprising a computer readable medium having instructions thereon, wherein the instructions, when executed in a computer, create a system for executing the method of claim 16.

24. A method for delivering user targeted information from a web server to a personal digital assistant (PDA), the method comprising:
entering a personal profile associated with a user, wherein the personal profile includes demographic information associated with the user;
entering a user-defined Uniform Resource Locator (URL);
initiating synchronization, wherein initiating synchronization includes:
generating a query as a function of the user's personal profile; and
transmitting the query to a web server;
selecting one or more Uniform Resource Locators (URLs) as a function of the queries;
receiving the selected Uniform Resource Locators (URL);
opening web pages corresponding to the received URLs and to the user-defined URL;
receiving HTML code corresponding to the web pages;
parsing the received HTML code; and
converting the parsed HTML code into a format appropriate for the PDA.

25. The method according to claim 24, wherein entering a personal profile includes selecting from pre-defined categories associated with an affinity group.

26. The method according to claim 24, wherein entering a personal profile includes entering geographic location information associated with the user.

27. The method according to claim 26, wherein the geographic location information includes a zip code.

28. The method according to claim 26, wherein entering a personal profile further includes selecting from pre-defined categories associated with an affinity group.

29. The method according to claim 24, wherein initiating synchronization further includes connecting the PDA to a computer connected to the Internet.

30. The method according to claim 24, wherein the selected URLs include URLs containing advertising targeted to users matching the demographic information associated with the user.

31. An article comprising a computer readable medium having instructions thereon, wherein the instructions, when executed in a computer, create a system for executing the method of claim 24.

32. A web server for delivering information targeted to a user, the web server comprising:
means for transmitting data over a network;
means for receiving a query generated from a personal profile associated with the user, wherein the personal profile includes demographic information associated with the user;
means for selecting one or more Uniform Resource Locators (URLs) as a function of the query; and
means for returning the selected URLs to the user over the network.

33. The web server of claim 32, wherein the means for receiving a query includes means for receiving a URL from the user.

34. The web server of claim 32, wherein the means for receiving a query includes means for receiving search parameters from the user and wherein the means for selecting one or more URLs includes means for selecting one or more URLs as a function of a search based on the search parameters.

35. The web server of claim 34, wherein the personal profile includes:
geographic location information associated with the user; and
one or more categories selected from pre-defined categories associated with affinity groups.

36. The web server of claim 35, wherein the means for receiving a query further include means for receiving a URL from the user.

37. A computer, comprising:
a processor;
a user interface, wherein the user interface includes means for entering a personal profile associated with a user, wherein the means for entering a personal profile includes means for selecting from pre-defined categories associated with an affinity group and means for entering geographic location information associated with the user;
means, connected to the processor and the user interface, for generating a query as a function of the personal profile; and
means for transmitting the query across a network to a web server.

38. The computer of claim 37, wherein the user interface includes means for connecting to a personal digital assistant (PDA).

39. The computer of claim 38, wherein the means for transmitting a query includes means for transmitting search parameters with the query and means for transmitting a URL with the query.

40. The computer of claim 37, wherein the means for transmitting the query includes means for transmitting a URL with the query.

41. The computer of claim 40, wherein the means for transmitting a query further includes means for transmitting search parameters with the query.

42. The computer of claim 37, wherein the means for transmitting a query includes means for transmitting search parameters with the query.

43. The computer of claim 37, wherein the geographic location information includes a zip code.
